(19) United States
(12) Patent Application Publication
(10) Pub. No.: US 2005/0010616 A1
(43) Pub. Date: Jan. 13, 2005

(54) System and method for restoring files

(76) Inventor: David P. Burks, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/615,626

(22) Filed: Jul. 9, 2003

(51) Int. Cl. G06F 17/30

(52) U.S. Cl. 707/204

(57) ABSTRACT

A method of backing up files includes storing a plurality of files on a local device, transmitting a list of the files to a backup/restoration service, identifying an ownership property associated with each of the files, and selectively restoring at least one of the files associated with an appropriate status of the ownership property. A system includes a storage medium configured to store a plurality of files, a communications link connected to the storage medium for transmitting a list of the files to a remote location, and a file server located at the remote location. The file server is connected to the communications link and operable to receive and store the list of files in response to a restoration request for selectively restoring files associated with an appropriate status of an ownership property associated with the files.

### FIELD OF THE INVENTION

The invention relates to information systems and more particularly to providing a backup and restoration system and method for data and files.

### DESCRIPTION OF RELATED ART

The proliferation of digital electronics, ever increasing data storage capabilities, and decreasing memory costs have brought about the wide distribution of digital data including, for example, digitized media in the form of audio and video programming. Users of personal computers, digital appliances, and similar devices and systems routinely store large amounts of data on local media such as magnetic and optical drives and flash memory. For example, the HEWLETT PACKARD®0 (HP) digital center DE100c is a dedicated, networked digital juke box capable of storing a large number of audio selections. The center includes a magnetic hard drive for storing MP3 encoded audio “ripped” from CDs or downloaded from the internet.

Application, data, audio, and video files may be obtained from sources such as removable physical media, floppy disks, CDs or in electronic form via the Internet. For example, consumers may acquire audio programming from sources such as audio cassette tapes, audio CDs, or MP3, .WAV, and similar audio formats available for download over the Internet. These audio files may be collected into one or more play-lists and stored on an appropriate digital medium, such as a computer hard drive or other mass storage device. Over an extended period of time, a user may build a personalized library of media content from a wide range of content sources. Therefore, if the content was lost or destroyed, it would be difficult, if not impossible, to reconstruct the user's library.

Restoration of data is a growing concern with system administrators and users of personal computers and digital appliances. Data may be lost for a variety of reasons including, for example, software and hardware failures, accidental loss, destruction of devices, and computer viruses. Therefore, various devices, systems, and methods have been developed to “backup” computer systems, digital appliances, and similar electronic devices. These backup systems typically store the user's data in a location separate from the original data. The backup data enables recovery and restoration of the original data if it is lost or corrupted. Such backup efforts focus on duplicating portions or the entirety of a primary mass storage device. During this duplication, files are copied onto an external device and/or a removable media storage device. However, such devices have several disadvantages such as the cost, space, and power required to maintain and operate the backup device, and the time required to perform a complete backup including transfer of large data files. Accordingly, a need exists for an enhanced system and method for restoring or backing up files.

### BRIEF SUMMARY OF THE INVENTION

A method of backing-up files comprises storing a plurality of files on a local device, identifying an ownership property associated with each of the files, transmitting a list of the files along with the associated ownership property to a backup/restoration service, and requesting restoration of at least one of said plurality of files.

A system comprises a storage medium configured to store a plurality of files, a communications link connected to the storage medium for transmitting a list of the files to a remote location, and a file server located at the remote location, the file server connected to the communications link and operable to receive and store the list of files and responsive to a restoration request for selectively restoring at least one of the files associated with an appropriate status of an ownership property associated with the files.

A computer program product comprises a computer usable medium having computer readable program code embedded therein, the computer readable program code comprising computer readable program code means for causing a computer to store a plurality of files on a local device, computer readable program code means for causing a computer to transmit a list of the files to a backup/restoration service, computer readable program code means for causing a computer to identify an ownership property associated with each of the files, and computer readable program code means for causing a computer to selectively restore files associated with an appropriate status of the ownership property.

A system comprises means for storing a plurality of files, means for receiving a list of files stored at a remote location, the list of files include an ownership property associated with each of the listed files, means for storing the list of files, means for receiving a restoration request from the remote location, and means for restoring the files to the remote location.

### BRIEF DESCRIPTION OF THE DRAWINGS

FIG. 1 is a diagram of a fault-tolerant file system.

FIG. 2 is a diagram depicting backup/restoration information stored in backup files; and

FIG. 3 is a flowchart depicting a method of backing-up and restoring a local database.

### DETAILED DESCRIPTION

Embodiments of the present invention include a system and method to provide services to consumers to achieve a virtual backup and restoration of files. In one embodiment, these restored files may comprise digital music collections stored on a PC or other internet connective device such as a digital juke box, MP3 player, or other digital appliance. The HP DE100c is an example of such a digital music juke box. Although embodiments of the invention are applicable to digital music collections, other embodiments are equally applicable to other types and formats of files and data. These embodiments include, for example, video, graphics, and other content and files that may be purchased or otherwise acquired and stored locally by a consumer. The backup is characterized as “virtual” as opposed to a conventional or “real” backup. The term “virtual” means that only a single copy of any given file, such as a music selection, is stored on a storage device maintained by a remote backup server. Thus, multiple users share this copy of the file as a source of restoration data in the event of data loss by a user.

Embodiments of the present invention further address verification that appropriate permission is available to provide copies of backup files and other material for restoration of lost, damaged, and/or corrupted files. In the case of digital music, such permission includes verification that the subscriber initiating a restoration request had previously properly acquired the music content to be restored, and therefore, the music files are eligible for restoration.

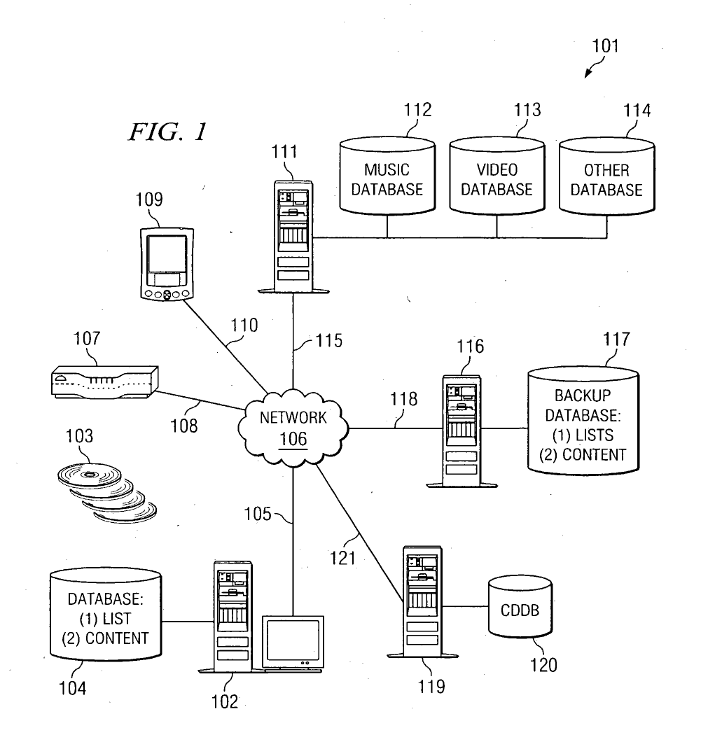

FIG. 1 is a diagram of a fault-tolerant file system including provisions for downloading content, obtaining associated descriptive performance information, extracting and storing information to backup locally-stored files and data, and providing several subscriber systems configured to utilize these resources. A block diagram of a content acquisition, backup and restoration system 101 supporting multiple subscribers is depicted in FIG. 1. A first subscriber may use personal computer (PC) 102 to store various types of program content. In the present example, that program content is in the form of music, acquired, for example, from audio CD 103. PC 102 includes a CD drive or player to read audio CDs. Appropriate software running on PC 102 is used to read the encoded music from audio CDs 103 and to reformat the data to be stored in database 104. This reformatting process may comprise encoding the audio in a suitable compressed file format such as the MP3 or AAC (Advanced Audio Coding) formats. PC 102 may be connected to a network 106, such as the Internet, via an appropriate communications link 105, which may be a conventional telephone line service, digital subscriber line (DSL), cable modem, or wireless link by way of an appropriate Internet service provider (ISP). Similarly, digital appliance 107 may comprise a digital tuner connected to network 106 via communications link 108. In a related manner, handheld device 109 may comprise a PDA or an MP3 player for storing and playing digitized music and may be connected to network 106 via a communications link 1 10.

Network 106 may, and typically will, include various communications systems and networks such as, but not limited to, those commonly supporting Internet and private and public wide and local area networks (WANS and LANS). Network 106 may provide digital packet connectivity between subscriber devices including PC 102, digital appliance 107, and handheld device 109 to content server 111, backup/restoration server 116, and performance information server 119. More specifically, content server 111 may include various sources and types of content including, for example, music database 112, video database 113, and other databases 114. Other databases 114 may include, for example, application programs, utilities, or other data and/or files that may be downloaded by a plurality of subscribers for their respective local storage and use. For the purposes of the present example only, audio in the form of music trades will be discussed although other content may be supported by the system and platforms described herein and any adaptations thereof.

Audio files stored in music database 112 may be compressed using a lossy compression algorithm such as MP3, AAC or other psychoacoustic compression techniques. Content server 111 may include appropriate distribution routines to provide downloads of content to authorized subscribers such as those purchasing content over the internet. Content server 111 may further include appropriate software for providing indicia designating an ownership property associated with downloaded files. The software is capable of identifying downloaded files as properly transferred and possessed or as appropriately owned by a subscriber system such as PC 102, digital appliance 107, or handheld device 109.

In one embodiment, the indicia of ownership may be included as a digital watermark impressed upon the content, and in another embodiment, the indicia may be represented by an auxiliary tag or identifier or by both a watermark and the auxiliary tag or identifier. Such tag or identifier may be in the form of metadata associated with the file that identifies the property rights that are transferred with the content file. Thus, the property rights may be used to indicate that a subscriber has properly obtained a copy of the content for use and restoration purposes or may include use limitations such as the right to play the content once, some limited number of times, or for some period of time.

Once the music files are identified as having been properly acquired and, therefore, properly eligible for restoration, a software application may be periodically run on the subscribers device (e.g., PC 102, PDA 109, MP3 player, or digital jukebox) to identify music tracks eligible for restoration and to communicate this information to backup/restoration server 116. The information at the backup/restoration server 116 may include subscriber information and identification of and relationships to all music files that have been properly acquired. In addition to music file information identifying audio tracks (e.g., content) and subscriber identification information, configuration information, play-list, and other data required to recreate a subscriber's data environment may be transmitted to backup/restoration server 116 for storage.

Backup/restoration server 116 includes a backup database 117 stored on a suitable mass storage device (e.g., magnetic hard drive). Backup database 117 includes lists of files that identify data (e.g., the music tracks) associated with respective subscribers that is subject to and eligible for restoration. Additionally, content to be used to restore lost data is also stored on backup database 117. In the event of a data loss, sufficient information may be stored on backup database 117 to restore and rebuild the subscriber's data as of the last backup instance. The restored content may be one or more files or even the entire content of a device or system, such as a computer hard drive. Thus, the system and method may be used to backup and, as necessary, selectively restore and recover individual files and to enable complete disaster recovery from failure of an entire mass storage device or system including restoration of all files stored thereon.

A restoration request is made by a subscriber and transmitted by network 106 to backup/restoration server 116 over communications link 118. Note that, preferably, only one copy of each selection is stored in backup database 117 along with lists designating which content files are associated with particular subscribers. The elimination of file duplication among the subscribers greatly reduces the amount of memory required to store content for backup and restoration purposes. In other embodiments, backup/restoration server 116 may store some limited number of copies of content files to provide some fault tolerance, to accommodate network considerations, and to support parallel restoration of popular music tracks.

Although backup/restoration server 116 may provide restoration copies of content to a requesting subscriber using an appropriate transmission system (such as communications link 118), restoration of large amounts of content may prefer other methods of providing both the restored files and any related program information to a subscriber. For example, backup/restoration server 116 may include a CDRW drive used to provide a set of restoration CDs that may be physically delivered to the requesting subscriber for local database restoration. Backup files and content may also be provided on a suitable high-density removable media device or may be provided on, for example, a replacement hard drive. Thus, a subscriber can send a repaired or replacement device to a service center associated with backup/restoration server 116 so that the original contents of the device can be restored. After the original contents have been restored, the repaired or replacement device is then returned to the subscriber and installed or used to locally download the recovered content. Such content may include, for example, a computer operating system, application and utility programs, device drivers, or data. Since many subscribers may rely on a single instance of a file for restoration purposes, storage requirements on backup/restoration server 116 are minimized. Further, since multiple subscribers may rely on the centrally archived backup copy of the files, each subscriber need not independently supply a copy of previously stored files. Even where subscriber files may slightly differ, known data compression techniques may be used to minimize the amount of storage required on backup/restoration server 116 to store information sufficient to reproduce the slightly differing files.

In addition to content, backup and restoration processing may provide related information and files to restore lost programming and to recreate a subscribers data environment. For example, performance information may be stored on server 119 and associated database 120. Database 120 may include performance information in the form of data available from the CDDB database including, for example, track titles, album, and artist name. This information may be retrieved from CDDB database 120 by performance information server 119. This information is then provided via communications link 121, network 106, and communications link 118 to backup/restoration server 116 to be associated with content stored on backup database 117. Restoration of the performance information may be specific to each subscriber requesting restoration services.

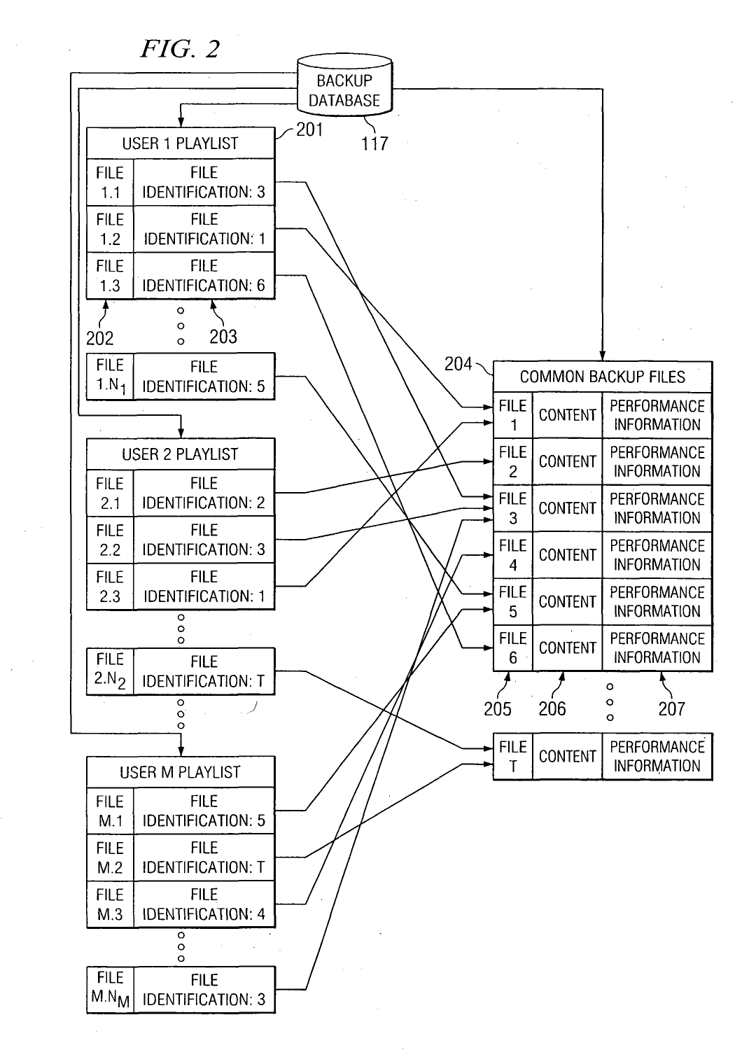

FIG. 2 is a diagram depicting backup/restoration information in the form of play-lists identifying content files (e.g., audio tracks). The content files are maintained by a plurality of users together with content and performance information. Additionally, the content files are all stored in common backup files that are referenced and used by the system to restore files that are identified in the various play-lists. FIG. 2 also depicts a possible file storage architecture present on backup database 117. In one embodiment, a plurality of playlists 201, which are associated with respective users, may include a record 202 for identifying each file subject to restoration. Each record 202 has some form of file identification 203 which identifies the content and any associated data to be restored. As shown in FIG. 2, a record 202 may include a pointer 208 or other addressing scheme to identify a storage location corresponding to the file designated in the particular user's play-list 201. Content and associated performance information may be stored in a file structure 204. File structure 204 includes a plurality of records 205 associated with respective files to be backed-up, in this case, in the form of audio materials (e.g., music tracks). Such files are stored as content file 206 and any related performance information 207 (e.g., track name). It should be noted that, for purposes of the present illustration and explanation, backup database 117 is shown as a mass storage device including a file structure. However, other forms of storage and data structures may be employed including, for example, relational data.

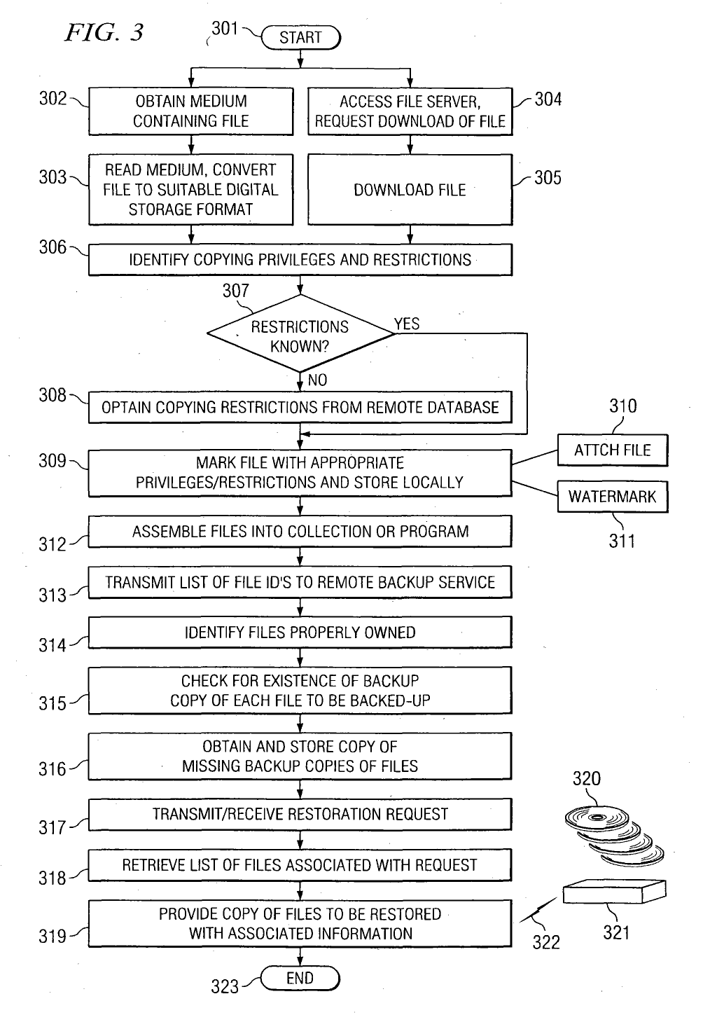

FIG. 3 is a flowchart depicting a method of backing-up and restoring a local database using a remotely maintained and updated backup file server. Starting at 301, subscribers acquire content in various ways. For example, subscribers acquire a desired file from an appropriate medium such as an audio CD having recorded thereon music. At 302 the subscriber uses conventional distribution systems such as retail outlets, or Internet sales websites, to obtain content. Once obtained, an appropriate device, such as a CD drive, reads the medium at 303 and then converts the file to a suitable compressed digital storage format such as MP3. Likewise, content may be obtained at 304 by accessing a file containing the desired content from an appropriate server and then requesting a download of the file. This download may be accomplished over the Internet and may involve purchasing of the content resulting in a download of the file at 305.

At 306, the system identifies ownership rights in the content so as to define copying privileges and restrictions. For example, in the case of a music CD, if the medium is a “stamped” CD, then an indication is that the user has in his or her possession an original version of the CD. Thus, the user may be entitled to “rip” a copy of the content for storage and playing on an alternative device such as a PC or digital appliance such as a digital jukebox. Property right information may also be associated with digital signatures contained within the content file or by associated files which provide property right information. Accordingly, at 306, copying privileges and restrictions are identified for the associated content. At 307, if restrictions are not available from the content supplier or source, the system accesses a remote database at 308 to obtain copying restrictions applicable to the content. At 309, content and associated files are appropriately marked with privileges and restrictions associated therewith and may be stored locally. Again, status of ownership and/or property rights associated with the files may be indicated by an attached file 310 or by appropriately watermarking the content at 311. Local storage of the content as marked in order to indicate rights necessary to backup the content and associated files may be supported by an appropriate mass storage device such as a magnetic hard drive.

Typically, a subscriber will assemble various files into a collection or program of materials at 312, defined by a play-list identifying tracks to be listed and/or played. After the entries in the play-list and/or other content and files comprising the collection have been properly acquired as indicated by the associated property right information, they may be compiled in a list of files to be transmitted to a remote back-up service at 313.

The backup server may make the property right determination instead of or in addition to any determination made by software resident on a subscriber device. For example, at 314, a backup/restoration server may identify files properly owned by a subscriber requesting backup services. These rights may be determined by inspection of content identification information indicative of content that may be copied and/or restored.

At 315, the backup/restoration server checks the list of files to be backed-up to ensure that a backup copy of each file is available, i.e., that the appropriate content and any associated performance information is stored in the backup database. If the content is not already available on backup database 117, then a copy of the missing backup content material (e.g., music track) is obtained at 316. Obtaining a copy of the missing content material may be accomplished by requesting that the subscriber provide a copy of the content or a copy of the content may be provided by and from other sources such as a music publisher or artist website.

In the event of a local loss of data due to, for example, a hardware or software failure, a subscriber may transmit a restoration request to the backup/restoration server at 317. The backup/restoration server receives the request, and at 318, retrieves a list associated with the requesting subscriber of files to be restored including content and performance information (e.g., artist name, album and track titles). At 319, a copy of the files to be restored and any associated information is provided. Such information is preferably provided by physical delivery of appropriate media containing the backup such as CD-ROMs 320 or any suitable mass storage media device 321. Alternatively, if appropriate bandwidth is available, electronic transmission 322 of the files may be accomplished for download by the subscriber. The method terminates at 323.

As described, embodiments of the invention provide for a backup and data restoration system to restore lost, damaged, and corrupted files and data. Backup and data restoration is completed by allowing a subscriber to provide a verified list of files that may be properly restored as indicated by some indicia of property rights in and to the files to be backed up. Thus, instead of transmitting the content of a file, a subscriber need only provide information identifying files to be restored in the event of a data loss together with data confirming the subscriber's right to be provided with a backup copy of the file to use in restoring properly acquired data. Although the file may include audio content, such as one or more tracks from a music CD, embodiments are applicable to other forms of data and in particular to data and information that may be part of a backup (i.e., restoration data) to be provided to a plurality of subscribers and thereby stored in common as a single occurrence. For example, certain application programs such as Microsoft's “Word” text processing application are so ubiquitous that a backup/restoration server according to an embodiment of the present invention need store a single copy of the application and use that copy in response to a restoration request.

1. A method of backing-up files, comprising:
storing a plurality of files on a local device;
identifying an ownership property associated with each of the files;
transmitting a list of the files along with the associated ownership property to a backup/restoration service; and
requesting restoration of at least one of said plurality of files.

2. The method according to claim 1 further comprising:
assembling said files into a collection, wherein said transmitting comprises transmitting indicia of said files included in said collection.

3. The method according to claim 1 further comprising:
transferring content information corresponding to said files to a digital storage medium; and
shipping said digital storage medium to a requestor of a restoration service.

4. The method according to claim 1 further comprising:
reading file information from a plurality of removable media;
converting a format of said file information; and
storing the converted files on the local device.

5. The method according to claim 1 further comprising:
storing, for each of the files, content and property right information.

6. The method according to claim 1 further comprising:
storing, for each file, content information including digitized audio data and property right information including indicia of an ownership right of said content information sufficient to allow making a restoration copy thereof.

7. The method according to claim 1 further comprising:
storing, for each of the files, content and performance information.

8. The method according to claim 1 further comprising:
storing audio files in a psychoacoustic compressed format.

9. The method according to claim 1 further comprising:
storing a single copy of an audio file for a plurality of subscribers designating said audio file in said list.

10. The method according to claim 1 further comprising:
associating indicia of copying rights with said files; and
selectively storing backup copies of said files on a remote storage medium in response to said indicia.

11. A system comprising:
a storage medium configured to store a plurality of files;
a communications link for transmitting a list of the files to a remote location; and
a file sever located at the remote location, said file server connected to the communications link and operable to receive and store the list of files and responsive to a restoration request for selectively restoring at least one of the files associated with an appropriate status of an ownership property associated with the files.

12. The system according to claim 11 wherein said storage medium further comprises a digital mass storage device configured to store said files in a compressed audio encoding format and a format associated with at least one of said files' respective property information indicative of a right to restore an associated one of said files.

13. The system according to claim 11 wherein said, file server further comprises a digital mass storage device configured to restore at least one of said files onto a restoration medium compatible with said storage medium.

14. The system according to claim 11 wherein said file server is further configured to store a plurality of said lists and a common copy of each distinctive file referenced by any one of said plurality of lists.

15 The system according to claim 11 wherein said storage medium comprises a digital audio system configured to store a plurality of audio files in a compressed format including a removable media player configured to read audio media and a communications link configured to download audio files from a network.

16. A computer program product comprising:
a computer usable medium having computer readable program code embedded therein, the computer readable program code comprising:
computer readable program code means for causing a computer to store a plurality of files on a local device;
computer readable program code means for causing a computer to transmit a list of the files to a backup/restoration service;
computer readable program code means for causing a computer to identify an ownership property associated with each of the files; and
computer readable program code means for causing a computer to selectively restore files associated with an appropriate status of the ownership property.

17. The computer program product according to claim 16 further comprising:
computer readable program code means for assembling said files into a collection, wherein said computer readable program code means for causing a computer to transmit comprises transmitting indicia of said files included in said collection.

18. The computer program product according to claim 16 further comprising:
computer readable program code means for reading file information from a plurality of removable media;
computer readable program code means for converting a format of said file information; and
computer readable program code means for storing the converted files on said local device.

19. The computer program product according to claim 16 wherein said computer readable program code means for causing a computer to store a plurality of files further comprises:
storing, for each of the files, content and performance information.

20. The computer program product according to claim 16 further comprising:
computer readable program code means for identifying a source medium as a stamped compact disc (CD);
computer readable program code means for recognizing watermarks present in said files; and
computer readable program code means for identifying metadata associated with said files.

21. The computer program product according to claim 16 wherein said computer readable program code means for causing a computer to store a plurality of files further comprises:
storing, for each of the files, content and property right information.

22. The computer program product according to claim 21 further comprising:
storing, for each file, content information including digitized audio data and property right information including indicia of an ownership right of said content information sufficient to allow making a restoration copy thereof.

23. A system comprising:
means for storing a plurality of files;
means for receiving a list of files stored at a remote location, the list of files include an ownership property associated with each of the listed files;
means for storing the list of files;
means for receiving a restoration request from the remote location; and
means for restoring the files to the remote location.

24. The system according to claim 23 further comprising:
means for transferring content information corresponding to said files to a digital storage medium; and
means for shipping said digital storage medium to a requestor of a restoration service.

25. The system according to claim 23 further comprising:
downloading one of said files from a remote server.

26. The system according to claim 23 further comprising:
means for reading file information from a plurality of removable media; and
means for converting a format of said file information wherein said means for storing a plurality of files further comprises storing the converted files on a local device.

27. The system according to claim 23 wherein said storing means further comprises storing, for each of the files, content and property right information.

28. The system according to claim 23 wherein said storing means further comprises storing, for each file, content information including digitized audio data and property right information including indicia of an ownership right of said content information sufficient to allow making a restoration copy thereof.
